(19) United States
(12) Patent Application Publication
(10) Pub. No.: US 2015/0009075 A1
(43) Pub. Date: Jan. 8, 2015

(54) ORTHOGONAL MULTI-ANTENNAS FOR MOBILE HANDSETS BASED ON CHARACTERISTIC MODE MANIPULATION

(71) Applicant: Sony Corporation, Tokyo (JP)

(72) Inventors: Buon Kiong Lau, Lund (SE); Hui Li, Lund (SE); Zachary Miers, Boulder, CO (US)

(73) Assignee: Sony Corporation, Tokyo (JP)

(21) Appl. No.: 14/050,761

(22) Filed: Oct. 10, 2013

Related U.S. Application Data
(60) Provisional application No. 61/843,172, filed on Jul. 5, 2013.

(51) Int. Cl. H01Q 5/00

(52) U.S. Cl. CPC H01Q 5/0024
USPC 343/702

(57) ABSTRACT

A novel multi-antenna design approach is proposed to obtain uncorrelated and energy efficient antennas. By manipulating the chassis, more than one characteristic mode is enabled to resonate at frequency below 1 GHz. With proper excitations for different characteristic modes, which are inherently orthogonal to each other, well performed multiple antennas with low mutual coupling and correlation are achieved. Three examples of chassis manipulation, a bezel structure and two T-shaped structures with metal strips along the chassis, are introduced. With efficient excitations of the fundamental dipole mode and T-strip mode, two antennas with low correlations and high total antenna efficiencies are achieved, with both antennas covering one or more of the low frequency LTE bands 5, 6, 8, 12, 13, 14, 17, 18, 19, and 20 in combination with one or more of high frequency LTE bands 1, 2, 3, 4, 9, 10, 11, 15, 16, 21, 23, 24, and 25.

### CROSS-REFERENCE TO RELATED APPLICATIONS

This application claims priority to U.S. Provisional Patent Application Ser. No. 61/843,172, filed Jul. 5, 2013, entitled “Orthogonal Multi-Antennas For Mobile Handsets Based On Characteristic Mode Manipulation,” the entirety which is incorporated herein by reference.

### BACKGROUND

Multi-antenna design in mobile handsets at frequency bands below 1 GHz is very challenging, since severe mutual coupling is induced by simultaneous excitation of the chassis' fundamental dipole mode by more than one antenna element. Severe mutual coupling through the chassis' fundamental dipole mode results in poor antenna efficiency and highly correlated received signals, leading to poor multiple-input multiple-output (MIMO) system performance. Therefore, there is a need for a novel multi-antenna design approach to obtain uncorrelated and energy efficient antennas.

### BRIEF SUMMARY

According to some embodiments of this invention, a novel multi-antenna design approach is proposed to obtain uncorrelated and energy efficient antennas. By manipulating the chassis structure, more than one characteristic mode is enabled to resonate at frequency below 1 GHz. With proper excitations for different characteristic modes, which are inherently orthogonal to each other, well performed multiple antennas with low mutual coupling and correlation are achieved. To demonstrate this antenna design approach, two different examples of chassis manipulations, a bezel structure and T-shaped structure with metal strips along the chassis are introduced, with each of the two structures capable of yielding a new characteristic mode resonating around 900 MHz and the T-shaped structure achieving a second resonance at around 1800 MHz. In particular, with efficient excitations of the fundamental dipole mode and T-strip mode of the modified chassis, two antennas with very low correlations and high total antenna efficiencies are achieved, with one antenna covering the LTE Band 8 (880-960 MHz) and the other antenna covering both LTE Band 5 (824-894 MHz) and LTE Band 8.

Embodiments of the invention are directed to systems and methods for obtaining uncorrelated and energy efficient antennas.

In some embodiments, a mobile apparatus comprises: a memory; a processor; and a chassis comprising at least one metallic part, the at least one metallic part enabling at least two antenna operational modes at frequency bands below 1 GHz. The at least one metallic part may have been previously present in the mobile apparatus (i.e., may have some other function in the mobile apparatus) or may be intentionally introduced into the mobile apparatus.

In some embodiments, a mobile apparatus comprises: a memory; a processor; and a chassis defined by a first edge and a second edge, the first edge being shorter than the second edge, the chassis comprising a bezel, the bezel being connected to a point near the center of the first edge using a shorting pin.

In some embodiments, the mobile apparatus enables at least two operational modes for the antennas, wherein the at least two modes comprise a fundamental dipole mode of the chassis and a bezel mode, and wherein the fundamental dipole mode and the bezel mode are substantially orthogonal to each other.

In some embodiments, the fundamental dipole mode has a larger bandwidth compared to the bezel mode.

In some embodiments, the fundamental dipole mode and the bezel mode are excitable substantially independently of each other.

In some embodiments, a mobile apparatus is provided that enables at least one characteristic mode to resonate at a frequency below 1 GHz. The apparatus comprises: a memory; a processor; and a chassis defined by a first edge, a second edge, and a third edge, the first edge being shorter than the second edge and the third edge, the chassis comprising: a first metal strip positioned along the second edge, the first metal strip being connected to a point near the center of the second edge using a first shorting pin; a second metal strip positioned along the third edge, the second metal strip being connected to a point near the center of the third edge using a second shorting pin.

In some embodiments, the mobile apparatus enables at least two operational modes at a frequency below 1 GHz, wherein the at least two modes comprise a fundamental dipole mode of the chassis and a T-mode.

In some embodiments, the T-mode is associated with at least one of the first metal strip or the second metal strip, and wherein the fundamental dipole mode and the T-mode are substantially orthogonal to each other.

In some embodiments, at least one of a resonant frequency or a bandwidth of the T-mode is based on a width of at least one of the first shorting pin or the second shorting pin.

In some embodiments, a resonant frequency and a bandwidth of the T-mode is based on a height of at least one of the first metal strip or a height of the second metal strip.

In some embodiments, the mobile apparatus further comprises a metal plate positioned substantially parallel to the chassis, the metal plate being configured to create capacitive coupling near the center of the second edge or the third edge, wherein the metal plate is connected to the first metal strip or the second metal strip, and wherein the metal plate is fed by a feeding strip.

In some embodiments, the fundamental dipole mode and the T-mode are excitable substantially independently of each other.

In some embodiments, first quadrilateral (e.g., square) shapes are etched into the first metal strip substantially symmetrically about the first shorting pin, and wherein second quadrilateral shapes are etched into the second metal strip substantially symmetrically about the second shorting pin.

In some embodiments, the T-mode covers the LTE Band 8 (880-960 MHz) and the fundamental dipole mode covers both LTE Band 5 (824-894 MHz) and LTE Band 8.

In some embodiments, a mobile apparatus is provided that enables at least one characteristic mode to resonate at a frequency below 1 GHz. The apparatus comprises: a memory; a processor; and a chassis defined by a first edge, a second edge, and a third edge, the first edge being shorter than the second edge and the third edge, the chassis comprising: a T-strip antenna comprising: a first metal strip positioned along the second edge, the first metal strip being connected to a point along the second edge using a first shorting pin; a second metal strip positioned along the third edge, the second metal strip being connected to a point along the third edge using a second shorting pin; a metal plate positioned substantially parallel to the chassis, the metal plate being configured to create capacitive coupling along the second edge or the third edge, wherein the metal plate is connected to the first metal strip or the second metal strip, and wherein the metal plate is fed by a first feeding strip; and a second antenna.

In some embodiments, operating the mobile apparatus enables at least two operational modes at a frequency below 1 GHz, wherein the at least two modes comprise a fundamental dipole mode and a T-mode, wherein the T-mode is associated with the T-strip antenna, wherein the fundamental dipole mode is associated with the coupled fed monopole antenna, and wherein the T-mode and the fundamental dipole mode are substantially orthogonal to each other.

In some embodiments, the second antenna comprises at least one of a monopole antenna, a planar inverted-F antenna (PIFA), or a slot antenna. When the second antenna is a coupled fed monopole antenna, the second antenna comprises a feeding strip, a coupling strip, and a radiator.

In some embodiments, the second antenna covers a larger bandwidth than the T-strip antenna. In some embodiments, the T-mode and the fundamental dipole mode remain substantially orthogonal to each other when a user is operating the mobile apparatus using either one hand or two hands.

In some embodiments, the first point is near or away from the center of the second edge, and the second point is near or away from the center of the third edge, which result in multi-band resonances.

In some embodiments, at least one of the second edge or the third edge is tapered along at least one end of the second edge or the third edge.

In some embodiments, the fundamental dipole mode and the T-mode cover one or more of the following low frequency LTE bands 5, 6, 8, 12, 13, 14, 17, 18, 19, and 20 in combination with one or more of high frequency LTE bands 1, 2, 3, 4, 9, 10, 11, 15, 16, 21, 23, 24, and 25.

In some embodiments, a mobile apparatus described herein may be a portable mobile communication device (e.g., a mobile phone, a watch, a computing device such as a tablet, or the like). In some embodiments, methods and/or computer program products for constructing and/or operating the various apparatus described herein may be provided.

### BRIEF DESCRIPTION OF THE DRAWINGS

Having thus described embodiments of the invention in general terms, reference will now be made to the accompanying drawings, where:

FIG. 1 presents characteristic eigenvalues over frequency for a 120 mm×60 mm chassis. The chassis material is Perfect Electric Conductor (PEC).

FIG. 2 presents (a) geometries of the bezel-loaded chassis, where the dimensions are: L=120 mm, W=60 mm, W_{b}=2 mm, h=3 mm, (b) eigenvalues of the bezel-loaded chassis, and (c) modal significance of the bezel-loaded chassis.

FIG. 3 presents geometries of the T-shape loaded chassis, where the dimensions are: L=120 mm, W=60 mm, W_{T}=0.5 mm, h₁=h₂=4 mm.

FIG. 4 presents (a) characteristic eigenvalues over frequency for the T-loaded chassis, and (b) modal significance for the T-shape loaded chassis.

FIG. 5 presents normalized characteristic currents of both modes at 900 MHz.

FIG. 6 presents characteristic patterns of the T-mode (mode 1) and dipole (D-) mode (mode 3) at 900 MHz.

FIG. 7 presents the normalized magnitude of electric and magnetic fields of both modes at 900 MHz.

FIG. 8 presents geometries of (a) T-mode antenna without meander line, and (b) T-mode antenna with meander line. The dimensions are: Lp=30 mm, Wp=6 mm, W_{f}=2 mm. The other dimensions are the same as in FIG. 3.

FIG. 9 presents magnitude of the reflection coefficient for the T-mode antenna with and without meander lines.

FIG. 10 presents geometries of the dual-antenna mobile terminal system. where the dimensions are: L_{T}=102 mm, Wᵣ=4 mm, Lᵣ=32 mm, L_{c}=37.5 mm, L_{f}=37.5 mm, h=3 mm.

FIG. 11 presents the S parameters of the dual-antenna mobile terminal system.

FIG. 12 presents simulated 3D radiation patterns of antennas at 880 MHz and 960 MHz.

FIG. 13 presents total efficiencies of the proposed antenna system and the reference antenna system.

FIG. 14 presents channel capacities for three different cases.

FIG. 15 presents positions of hand(s) with respect to the terminal antennas for (a) one-hand data mode and (b) two-hand data mode.

FIG. 16 presents magnitudes of S parameters for (a) one-hand data mode and (b) two-hand data mode.

FIG. 17 presents (a) envelope correlation for three different scenarios, and (b) antenna total efficiencies for three different scenarios.

FIG. 18 presents channel capacities for different user scenarios.

FIG. 19 presents the prototype of the dual-antenna mobile terminal system, comprising the coupled monopole and the T-strip antenna.

FIG. 20 presents the measured S parameters of the dual-antenna mobile terminal system, comprising of the coupled monopole and the T-strip antenna.

FIG. 21 presents simulated and measured antenna patterns for the co-located antenna system: (-) measured E(theta), (- -) simulated E(theta), (- -) measured E(Phi), (-) simulated E(Phi).

FIG. 22 presents the measured efficiencies of the dual-antenna mobile terminal system.

FIG. 23 presents T-strip structure that allows for multiband, multimode operation.

FIG. 24 presents currents that are formed in the structure for each mode of operation in the lowest band of operation.

FIG. 25 presents reflection and coupling coefficients of Mode 1 and Mode 2.

FIG. 26 presents far field pattern of Mode 1 low band.

FIG. 27 presents far field pattern of Mode 2 low band.

FIG. 28 presents far field pattern of Mode 1 high band.

FIG. 29 presents far field pattern of Mode 2 high band.

FIG. 30 presents far field envelope correlation coefficient of Mode 1 and Mode 2.

FIG. 31 presents single-band T-strip structure simulated with battery (top view).

FIG. 32 presents single-band T-strip structure simulated with battery (side view).

FIG. 33 presents simulated S parameters of single-band T-strip structure without battery.

FIG. 34 presents simulated S parameters of single-band T-strip structure with battery.

FIG. 35 presents a simulation mode of the T-strip structure with glass display

FIG. 36 presents simulated S parameters of multiband T-strip structure without glass display.

FIG. 37 presents simulated S parameters of multiband T-strip structure with glass display.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

### I. INTRODUCTION

Multi-antenna design in mobile handsets at frequency bands below 1 GHz is very challenging, since severe mutual coupling is induced by simultaneous excitation of the chassis' fundamental dipole mode by more than one antenna element. According to some embodiments of this invention, a novel multi-antenna design approach is proposed to obtain uncorrelated antennas. By manipulating the chassis structure, more than one characteristic mode is enabled to resonate at frequency below 1 GHz. With proper excitations for different characteristic modes, which are inherently orthogonal to each other, well performed multiple antennas with low mutual coupling and correlation are achieved. To demonstrate this antenna design approach, T-shaped metal strips along the chassis are used to modify the chassis, in order to yield a new characteristic mode resonating around 900 MHz. With efficient excitations of the fundamental dipole mode and T-strip mode of the modified chassis, two antennas with very low correlations are achieved, with one antenna covering the LTE Band 8 (880-960 MHz) and the other antenna covering both LTE Band 5 (824-894 MHz) and LTE Band 8. Good MIMO performances are achieved with the proposed design approach. User scenarios (one-hand data mode and two-hand data mode) show the robustness of the proposed antenna system. The proposed dual-antenna design is fabricated and measured. Good agreement is observed between the measured and simulated results.

The increasing popularity of smart phones and mobile internet has spurred the growing demand for high speed mobile communications, which in turn led to the widespread adoption of multiple-input multiple-output (MIMO) technology in wireless communication standards. MIMO utilizes multiple antennas in both base stations and terminals to enable linear increase in channel capacity with the number of antennas, without sacrificing additional frequency spectrum and transmitted power. In user terminals, limited by their relatively small size, integration of multiple antennas is challenging. Severe mutual coupling between closely spaced terminal antennas degrades the terminals' MIMO performances, such as correlation, diversity gain and capacity.

Accordingly, many effective decoupling techniques have been reported in the literature, such as the use of multiport matching networks, ground plane modification, neutralization line, and parasitic scatterer. More recently, highly isolated terminal antenna ports are achieved by exciting three different characteristic modes of a 120 mm×60 mm mobile chassis at 2.5 GHz. However, the required matching network is complicated in this multi-antenna system, resulting in limited total antenna efficiencies in practice. Besides, most of the aforementioned decoupling techniques are only demonstrated for terminal applications at frequency bands above 1.8 GHz.

For frequencies below 1 GHz, the existing decoupling techniques are no longer adequate to enable good MIMO antenna design, especially when taking both mutual coupling and antenna bandwidth into consideration. This is because the mobile chassis is of the right dimensions to be excited and shared by more than one antenna element, making space, angle and polarization diversities difficult to achieve. To mitigate the chassis-induced coupling, existing strategies are that one antenna is used to excite the chassis (to obtain good bandwidth and gain performance), whereas the other antenna(s) minimizes chassis excitation by either: (1) optimizing the antenna location, or (2) using magnetic antenna types based on the electric and magnetic field distributions of the chassis' fundamental dipole mode, or (3) localizing the current to the vicinity of the antenna element. However, the bandwidth of the non-chassis-exciting antenna(s) is usually limited due to it being electrically small and not taking advantage of the chassis to radiate.

Chassis modifications, such as etching a slot, implementing a wavetrap, or mounting a parasitic scatterer have been investigated for different applications. However, these methods are not used to obtain low frequency multi-antenna designs from the perspective of characteristic mode modification. On the other hand, a current trend in mobile phone design is to use metallic structure(s) in the casing (e.g., bezels) for mechanical or aesthetics reasons, which also modify the chassis properties to some extent. Unintentionally, due to the phenomenon of chassis excitation, the metallic structure often becomes a part of the antenna and hence it varies the internal antenna performance. Sometimes, the metallic structure needs to be redesigned to restore the desired performance of the internal antennas. In fact, some devices even use the metallic bezel in the housing of the phone as an external antenna.

According to some embodiments of this invention, a novel approach to design multi-antennas in mobile handsets is proposed by manipulating the chassis in a reasonable manner, in order to allow more than one characteristic mode to be effectively excited below 1 GHz. Two different modifications on the terminal casing (i.e. bezel-loaded chassis and T-strip loaded chassis) were studied and compared. For both structures, a new mode apart from the original dipole mode was generated to resonate below 1 GHz. The T-strip loaded chassis was finally chosen to design multi-antennas due to the corresponding second mode (or “T-mode”) providing a larger bandwidth. To effectively excite one mode without disturbing the other, proper feeding techniques were analyzed. Based on the analysis, a dual-antenna system with high port isolation and low correlation was designed for the given T-strip loaded mobile chassis. The performance of the proposed dual-antennas was then evaluated in both free space and different user scenarios. The results indicate that the proposed dual-antennas are robust to user influence.

The specification is organized as follows: In Section II, two different chassis modifications are studied in the framework of characteristic mode analysis. The potential of the modified chassis in providing uncorrelated antennas are demonstrated. Based on the T-strip loaded chassis, the feeding technique to effectively excite the T-mode and single antenna design are studied in Section III. Thereafter, design and simulations of orthogonal dual-antennas on the chassis are carried out in Section IV. MIMO performance analysis and different user scenarios are studied in the same section. In Section V, a prototype of the proposed multi-antenna terminal was fabricated, and the measured results are presented.

### II. CHASSIS MODIFICATION

Characteristic mode analysis is an efficient method to gain physical insights into potential resonant and radiation characteristics of a structure by finding and examining its inherent modes. The characteristic modes are independent of the excitation, and only depend on the shape of the structure. The analysis on these modes provides valuable information for antenna design.

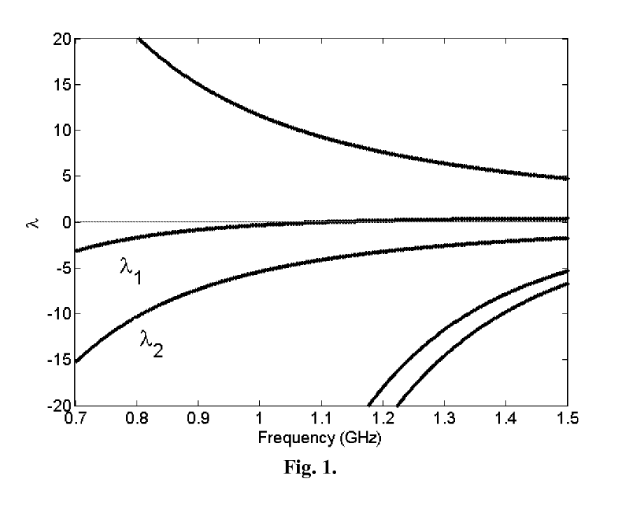

To begin with, the characteristic modes of a terminal planar chassis with the size of 120 mm×60 mm were calculated using the method of moments (MoM) based on the Theory of Characteristic Mode (TCM). The eigenvalues of the planar chassis are shown in FIG. 1. The modes are numbered according to the order of occurrence of its resonant frequency. It is observed that only one mode (λ₁) can resonate at around 1 GHz, which is the flat dipole mode along the length of the chassis. This mode can be easily excited by electric antennas (i.e., antennas whose near-field are dominated by electric field) implemented on the short edges of the chassis. Due to the common use of electric antennas in terminals and the short chassis edges being convenient for antenna integration, severe mutual coupling among multi-antennas at frequencies around 1 GHz can often be attributed to simultaneous excitation of the same dipole mode by the multi-antennas. To obtain more characteristic modes that can resonate at around 1 GHz, the chassis structure should be modified, as illustrated by two examples below.

### A. Bezel-Loaded Chassis

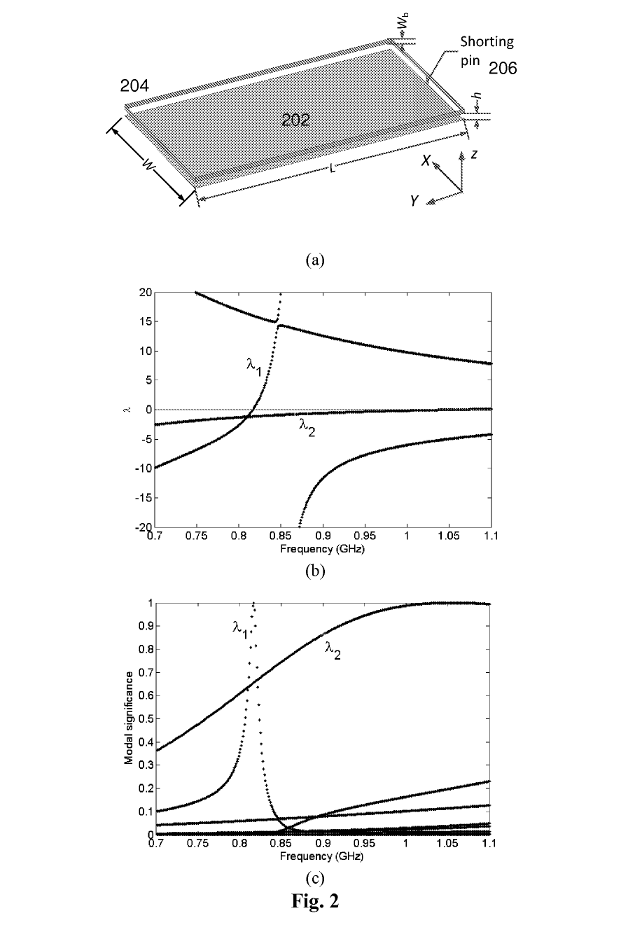

The first example of chassis modification is to load the chassis 202 with a bezel 204 along its periphery, with the bezel 204 connected to the center of the chassis' one short edge through a shorting pin 206. The geometries of the bezel-loaded chassis 202 are shown in FIG. 2 (a). From the fabrication perspective, the bezel 204 and the shorting pin 206 can be conveniently integrated onto the mobile casing.

The eigenvalues of the bezel-loaded chassis are calculated using the MoM and presented in FIG. 2 (b). At low frequency bands, it is observed that apart from the fundamental dipole mode, which is labeled as λ₂ in the figure, a new bezel mode (λ₁) is generated, whose eigenvalue is close to zero at frequencies around 0.81 GHz. With those two inherently orthogonal modes at the same frequency band, there is an opportunity to build uncorrelated antennas through proper excitations.

To show the contribution of each mode in an explicit way, modal significance, defined by

$$MS = \vert \frac{1}{1 + j {λ}_{n}} \vert \qquad ( Equation 1 )$$

is plotted in FIG. 2(c). The modal significance of the bezel-loaded chassis reveals that the dipole mode has a large bandwidth, whereas the bandwidth of the bezel mode is narrow. From the cellular communication perspective, it is difficult for the bezel mode to satisfy the bandwidth requirement of cellular bands below 1 GHz.

### B. T-Strip Loaded Chassis

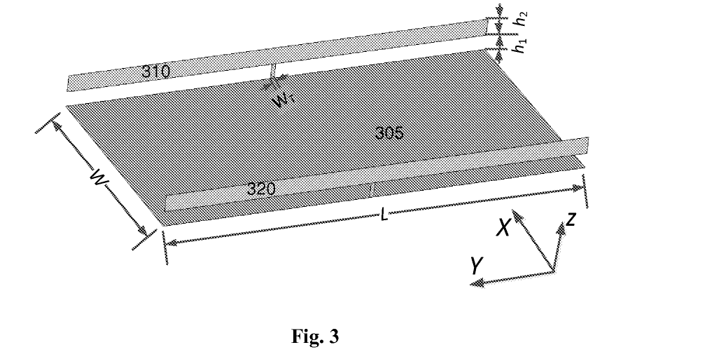

In this subsection, a T-strip loaded chassis 305 that provides a larger bandwidth potential is investigated. The geometries of the T-loaded chassis 305 are shown in FIG. 3. Two metal strips 310, 320 along the length of the chassis are connected to the chassis through shorting pins at the center of each strip. The simple T-strip modification can be accommodated within typical dimensions of a smart phone, making it possible to implement in reality.

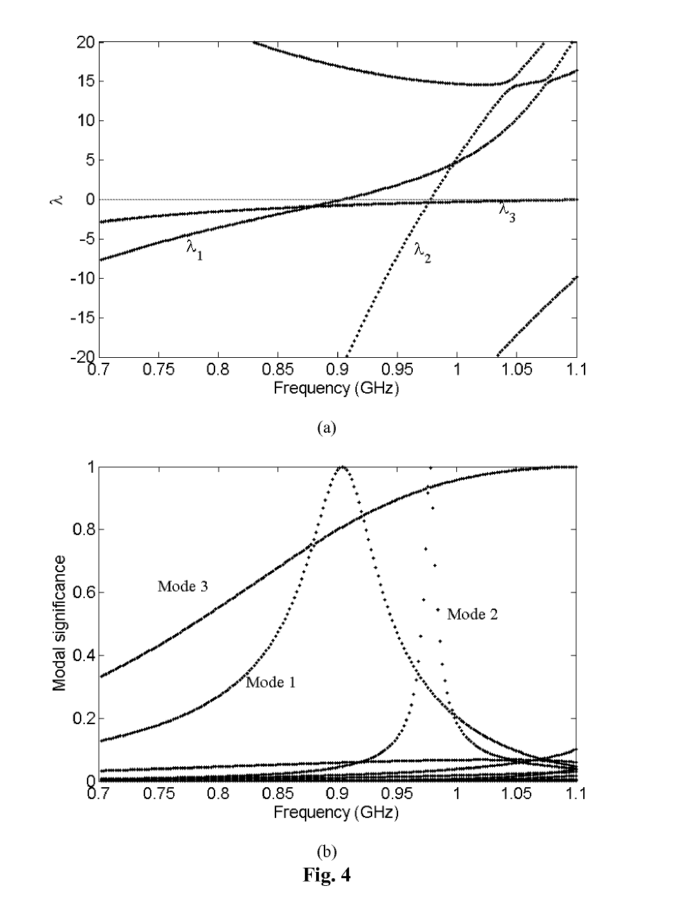

Using MoM, the eigenvalues of the T-strip chassis are calculated and shown in FIG. 4(a). Three resonant modes are observed at frequencies below 1 GHz. Since mode 2 (λ₂) has the narrowest bandwidth, it is not considered for the designing of antennas. Mode 1 corresponds to the T-strip mode, whereas mode 3 is the fundamental dipole mode.

The modal significance of the T-strip loaded chassis is plotted in FIG. 4 (b). If a modal significance criterion of 0.5 is considered, two orthogonal modes are likely to be excited to resonant within the bandwidth of 850-950 MHz. Mode 3 has an even larger bandwidth. Therefore, once properly excited, modes 1 and 3 can be used to achieve uncorrelated multi-antennas with good bandwidth. The feeding techniques for these two modes will be studied in Section III.

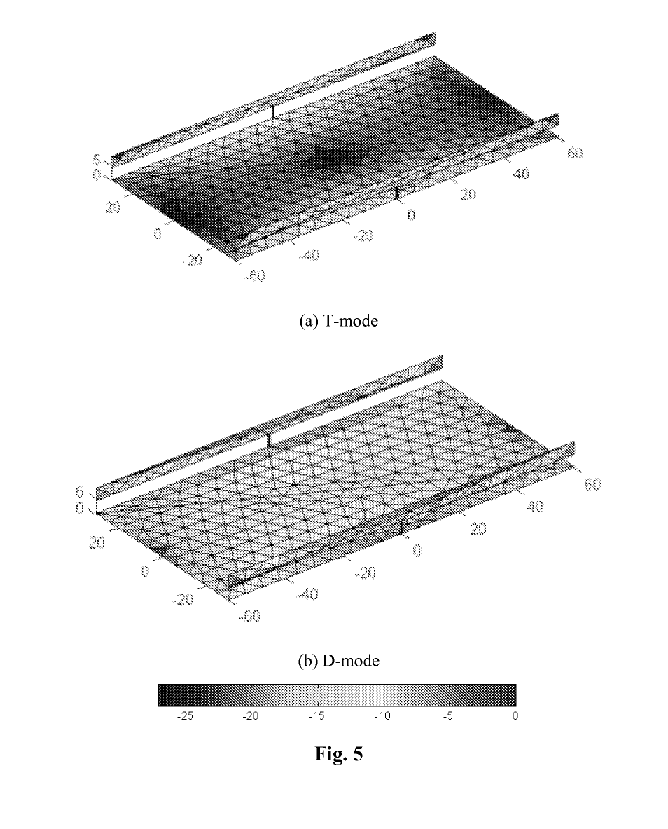

The current distributions of the T-mode and the dipole mode (D-mode) at 900 MHz are presented in FIG. 5. As expected, the D-mode shows strong currents all over the chassis, particularly along the length of the chassis. The current of the T-mode, on the contrary, focuses on the two metal strips, which exhibits the characteristic of a capacitively loaded dipole along the width (x axis) of the chassis.

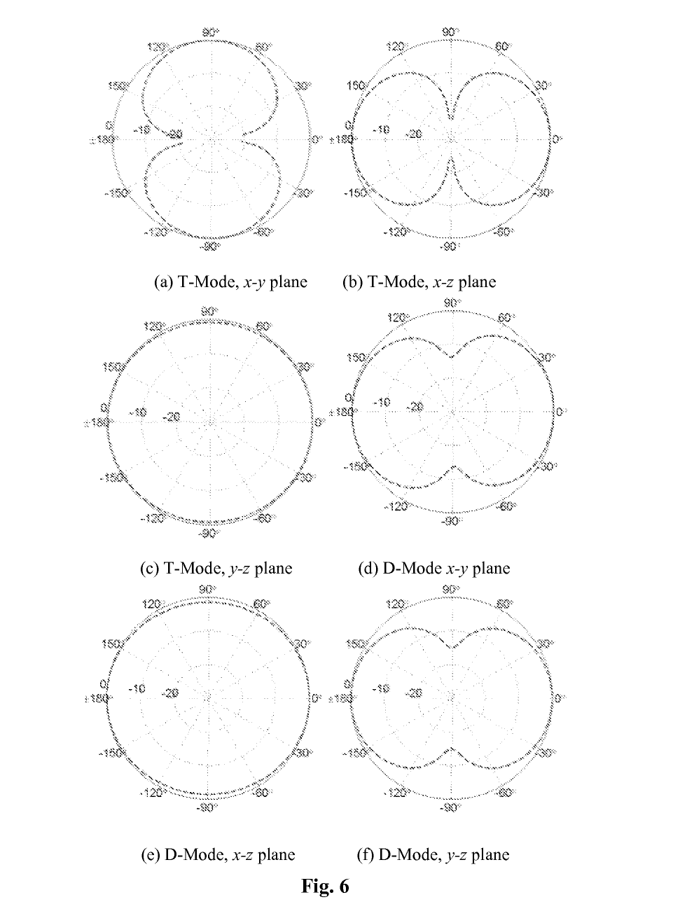

FIG. 6 shows the characteristic far-field patterns of the two modes. For the T-mode, the patterns on both x-y and x-z planes show a ‘figure-of-eight’ characteristic, and it is omnidirectional on the y-z plane. The patterns are consistent to those of an electric dipole along x axis, which further confirms the observation from the current distributions in FIG. 5(a). The patterns of the D-mode, on the other hand, exhibit a dipole placed along y axis. Though the magnitudes of the patterns of the two modes have some overlaps on the x-z and y-z planes, the polarizations of the two modes are different and hence they remain uncorrelated.

The width of the shorting pin (W_{T}) is critical to the resonant frequency of the T-mode and its bandwidth. When the shorting pin becomes wider, the resonant frequency increases, and the bandwidth becomes larger. Apart from W_{T}, the reduction of the total height (h₁+h₂) of the T-strip increases the resonant frequency and decreases the bandwidth of the T-mode. It is noted that the individual heights of h₁ and h₂ do not significantly affect the performance of the T-mode, if the total height is kept constant. This provides the mobile phone designers more freedom to determine the structure of the casing. The performance of the D-mode does not change with the variation of the T-strip.

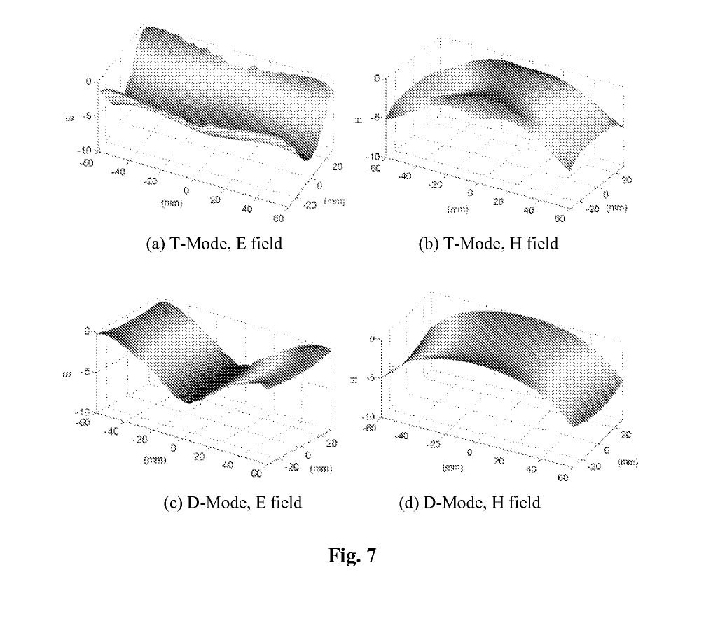

The reactive near-fields of the T-strip chassis are analyzed in order to provide valuable information for antenna feedings in Section III. The normalized magnitude of the characteristic electric and magnetic fields on a plane 10 mm above the chassis for both the T-mode and the D-mode are shown in FIG. 7. It is seen that the magnitudes of total magnetic fields of the two modes are similar with each other, while the magnitudes of the total electric fields differ significantly. The x, y, z components of the E and H fields are also studied, though it is not shown in the figure due to limited space. The E fields of both modes are dominated by the E_{z} component. For the magnetic field, Hₓ plays an important role for the T-mode, whereas H_{y} dominates for the D-mode. As expected of orthogonal modes, the reactive near fields of the two modes show good orthogonality.

### III. SINGLE ANTENNA DESIGN BASED ON T-MODE

In order to excite a certain mode of the chassis, the biggest challenge is to find the effective feeding structure and feeding locations. For the fundamental D-mode of the chassis, which is well known and frequently utilized for mobile antennas, there exists a number of excitation methods, such as a PIFA or a monopole placed on a short edge of the chassis. Consequently, in this section, the focus is on the antenna design for the newly introduced T-mode of the chassis. Full-wave antenna simulations were carried out in the frequency domain using CST Microwave Studio.

The main strategy for feeding the T-mode is to obtain good impedance matching and large bandwidth for the T-mode without exciting the D-mode. One way to determine the optimal feed location is by looking into the locations of the minimum and maximum characteristic currents for each driven mode. According to this approach, a direct feeding at one of the shorting pins is applied in order to excite the T-mode, since the current is strong along the shorting pins. A resonance was successfully created in the simulation; however, the impedance matching was poor due to the small radiation resistance of around 10Ω.

To obtain a better feeding method, the reactive near-field behaviors of the characteristic mode were studied, since they give insights into where the coupled energy can be maximized for a given mode, while reducing the probability of coupling to other modes. The difference of electric fields between the T-mode (FIG. 7(a)) and the D-mode (FIG. 7(c)) enables the excitation of one mode without much affecting the other mode. If capacitive coupling, which corresponds to the magnitude of the electric field, is created at the center of the chassis' longer edge, mainly the T-mode is excited. D-mode is not excited because its characteristic E field is very small at this feeding location. Similarly, if the capacitive coupling is located at the center of the shorter edge of the chassis, mainly the D-mode is excited.

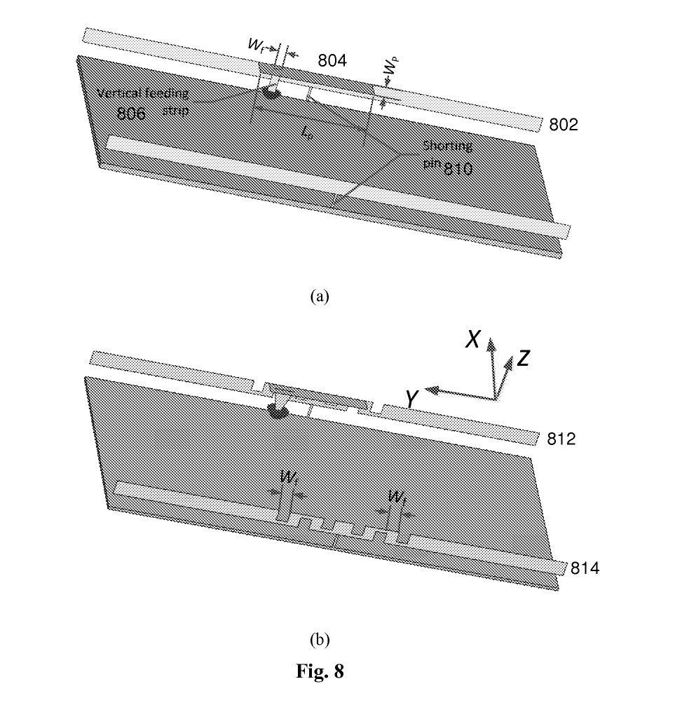

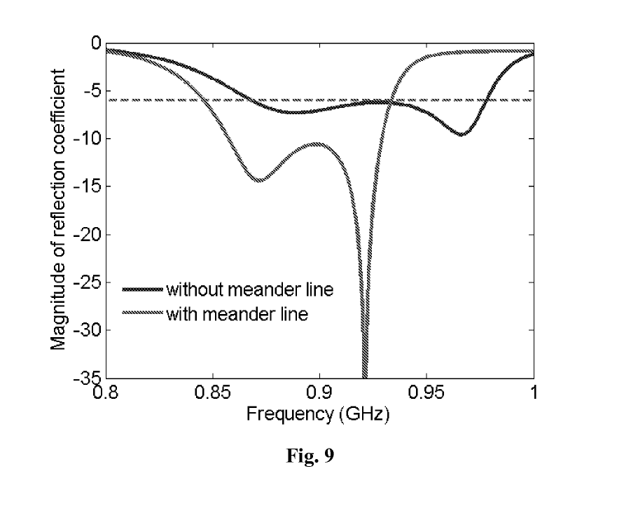

Based on the above analysis, the T-mode antenna is designed with its geometries shown in FIG. 8(a). A small narrow plate 804 parallel to the chassis is used to create capacitive coupling (i.e. reactive E_{Z} component) in vicinity of the center of the chassis' longer edge, in order to excite the T-mode. The plate 804 is connected to one of the T strips 802, and it is fed by a vertical strip 806 with a lateral distance of 2 mm from the T strip 802. The width of the shorting pin 810 is 0.5 mm. A discrete port (indicated by the red arrow in FIG. 8 (a)) is used in the simulation to feed the antenna, and a lumped capacitance of 1.5 pF is applied at the port to improve the impedance matching. For ease of fabrication, a FR4 substrate, with a permittivity of 4.3, a loss tangent of 0.014 and a thickness of 0.8 mm, is utilized under the ground plane. It has been verified in the simulation that the substrate does not significantly affect the resonant frequency and the bandwidth of the T-mode. The magnitude of the reflection coefficient for the T-shape antenna (blue curve) is shown in FIG. 9. It is observed that the 6 dB impedance bandwidth of the antenna is from 868 MHz to 979 MHz, which covers the full LTE Band 8.

To show the possibility of the antenna to resonate at lower frequency bands, modifications are made to the T strips 812, 814, as presented in FIG. 8(b). In order to increase the electrical length of the T-mode, square shapes with a width of 3 mm are etched symmetrically about the shorting pin on each of the two T-strips 812, 814 to form meandered structures. The distance between the adjacent squares is also 3 mm. Since the characteristic currents of the T-mode are strong in vicinity of the center of the strips 812, 814 (see FIG. 5(a)), each strip structure is mainly meandered around the center to maximize the effectiveness of lowering the resonant frequency. The vertical feeding strip is tapered due to its better impedance matching behavior. For comparison, the reflection coefficient of the meandered T-mode antenna is also shown in FIG. 9. The center frequency of the antenna is reduced by 30 MHz after it is meandered. As a trade-off, the bandwidth of the T-mode is reduced from 111 MHz to 90 MHz.

### IV. ORTHOGONAL DUAL ANTENNA SYSTEM

### A. Antenna Structures

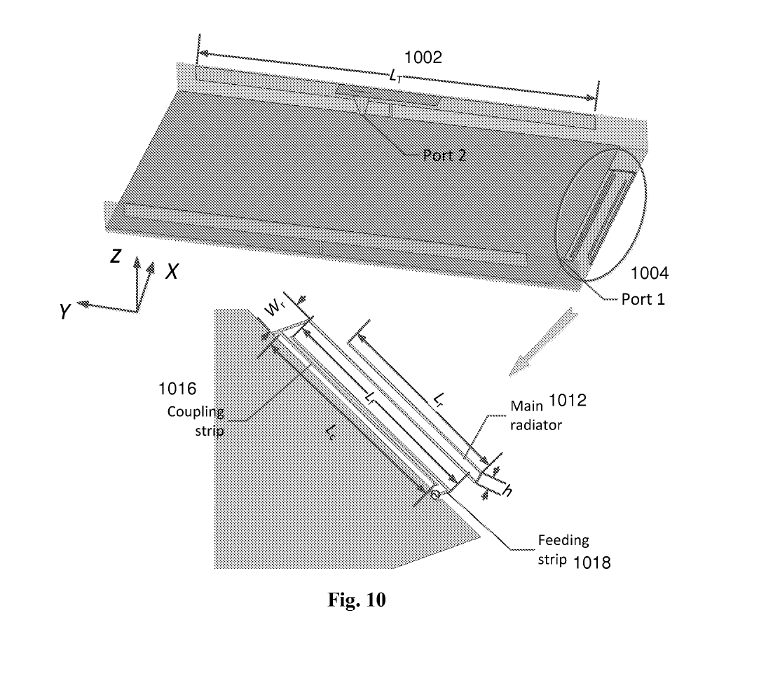

In this section, a practical MIMO terminal antenna system, comprising of a coupled fed monopole antenna 1004 and a T-strip antenna 1002, is proposed. Monopole antennas can effectively excite the D-mode of the chassis to obtain a large bandwidth. The geometries of the antenna system are presented in FIG. 10. The monopole 1004, with a volume of 40×7×3 mm³, is comprised of three parts: the feeding strip 1018, the coupling strip 1016 and the main radiator 1012. It is mounted onto a hollow carrier, which is hidden in the figure for a better view. The carrier has a thickness of 1 mm, a permittivity of 2.7 and a loss tangent of 0.007. To keep the surface area of the mobile phone to 120 mm×60 mm, the chassis ground plane was shortened to 113 mm to provide space for the monopole antenna. For ease of fabrication, the T-strips were printed on the same FR4 substrate as in Section III. Due to the higher permittivity (4.3) of FR4 compared with air, the wavelength on it becomes smaller. To maintain the same resonant frequency of the T-strip antenna, the length of the T-strip is reduced. If a lower resonant frequency is desired, the strip length can be increased. Alternatively, the strip may be meandered, as suggested in Section III.

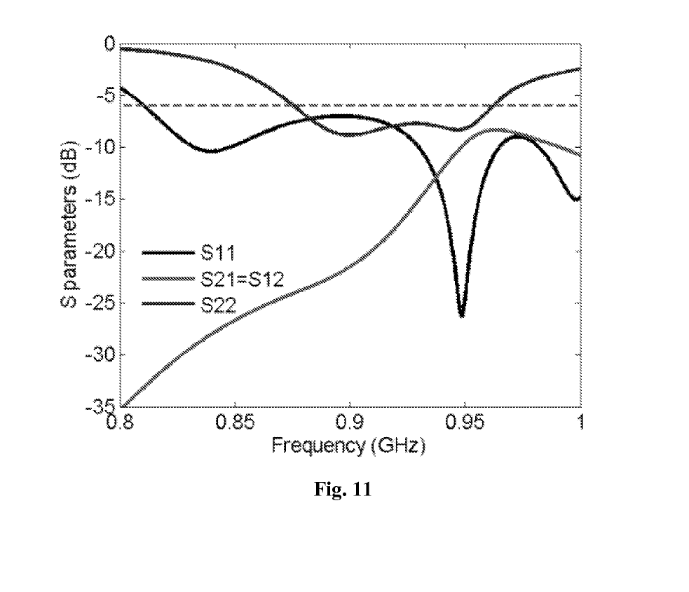

The simulated magnitudes of the scattering (S) parameters for the dual-antenna terminal are shown in FIG. 11. The T-strip antenna operates within the bandwidth of 875-964 MHz, and the monopole covers a larger bandwidth from 809 MHz to 1 GHz. The antenna isolation is above 8.5 dB within the common band of both antennas. In particular, for frequencies below 935 MHz, the isolation is above 15 dB. This is owing to the orthogonality of the two modes, i.e., the D-mode and the T-mode, created by the two antennas. However, the isolation becomes worse as the frequency increases towards 964 MHz. This can be explained by the modal significance in FIG. 4 (b), where the D-mode provides the dominant contribution at frequencies above 950 MHz. The total surface current is given by

$${J}_{s} = {\sum }_{n} \frac{{V}_{n}^{ex} {J}_{s , n}}{1 + j {λ}_{n}} , \qquad ( Equation 2 )$$

where Vₙ^{ex} and J_{s,n} represent the external excitation and surface currents for mode n. Therefore, the total current distribution depends on both the excitation and the significance of the relevant modes. Though the feeding of the T-strip antenna is at a suitable location to efficiently induce the T-mode at the center frequency of around 900 MHz, it is difficult to guarantee that it does not affect the D-mode over the whole operating band. At frequencies close to 960 MHz, the D-mode also contributes to the total current due to its higher modal significance (above 950 MHz) as well as the feeding location not being optimized for exciting only the T-mode at these frequencies. As a result, the overall pattern is a combination of the D-mode and the T-mode, deteriorating the orthogonality between the ports and leading to worse isolation than that achieved at lower frequencies. This can be more intuitively explained by the radiation patterns of the two antennas at different frequencies.

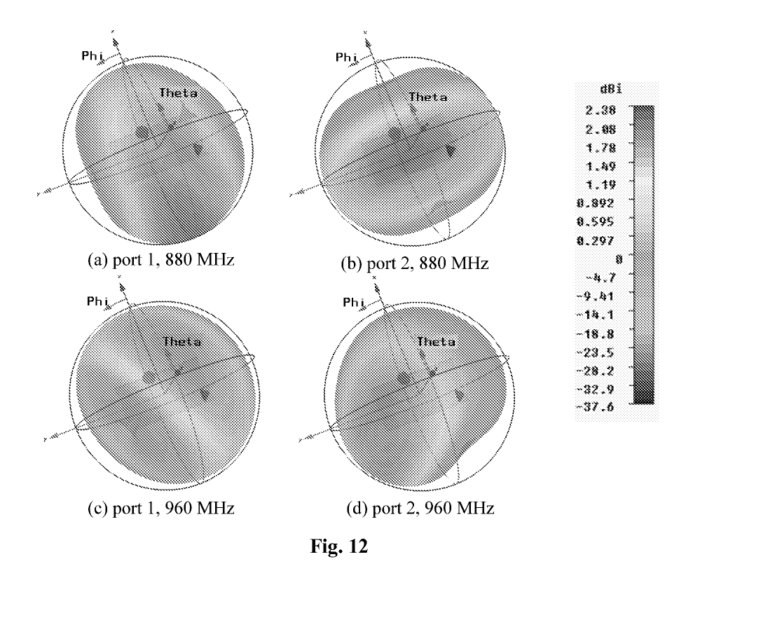

The radiation patterns of both antennas at 880 MHz and 960 MHz are shown in FIG. 12. At 880 MHz, port 1 and port 2 exhibit typical radiation patterns as a dipole along y axis (D-mode) and a dipole along x axis (T-mode), respectively. The slight tilt in the pattern for port 1 is due to the off-centered feeding location of the coupled monopole. At 960 MHz, the D-mode of the chassis makes some contributions when port 2 is excited, so that the radiation pattern of port 2 is a combination of both modes. However, it is observed that the radiation patterns of the two antennas still differ a lot from each other, which ensures a low correlation, even at 960 MHz.

### B. MIMO Performance

MIMO channel capacity is one of the most popular metrics for evaluating the performance of multiple antenna systems. The capacity is calculated for different frequencies under the waterfilling (WF) condition for a reference SNR of 20 dB. The WF procedure is performed over the antenna elements at each frequency. The Kronecker model and uniform 3D angular power spectrum (APS) are assumed. There is no correlation between the (base station) transmit antennas, whereas the (terminal) receive antennas are correlated according to their patterns and the uniform 3D APS. The capacity is averaged over 10,000 identical and independently distributed (IID) Rayleigh realizations at each frequency. The channels are normalized with respect to the IID Rayleigh case, which means that the correlation, total efficiency and efficiency imbalance are taken into account in the capacity evaluation.

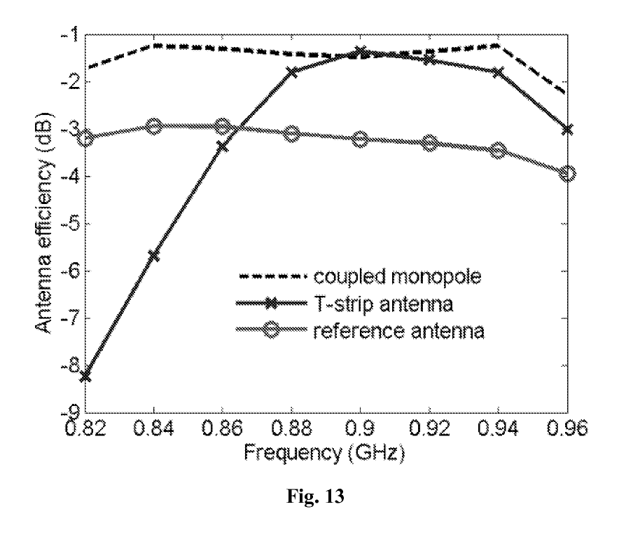

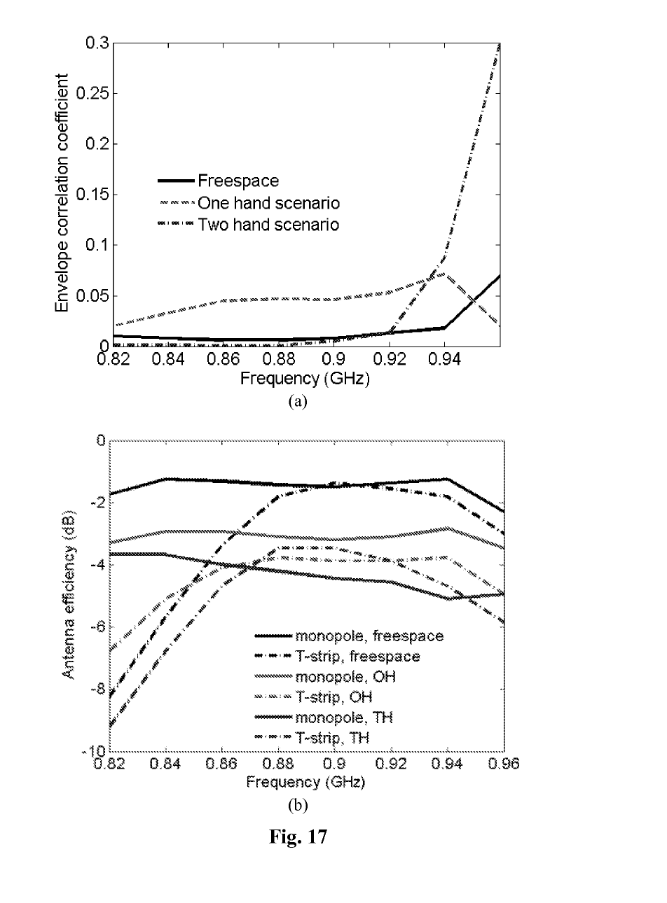

The total efficiencies of the antennas are presented in FIG. 13. Within LTE Band 8, the efficiency of the monopole antenna and the T-strip antenna is around −1.5 dB and −2 dB, respectively. The monopole antenna also radiates efficiently at LTE Band 5, at which the efficiency of the T-strip antenna is low due to poor impedance matching. The correlation coefficients of the proposed dual-antenna terminal are shown in FIG. 17(a).

To make a comparison, a reference dual-antenna terminal is also simulated, with antenna total efficiencies also shown in FIG. 13. The reference antenna system comprises of two identical antennas, with each being of the same design as the monopole in FIG. 10, and located at the two short edges of the chassis. The reference antenna terminal covers both LTE Band 5 and Band 8 according to the 6 dB impedance matching criterion, with an isolation of around 7 dB between the antenna elements. Since the two antennas are identical, their total efficiencies are the same so that only one curve is shown in FIG. 13. Though the monopoles in the reference antenna terminal are the same as the one used in the proposed antenna terminal, their efficiencies are lower because of higher mutual coupling.

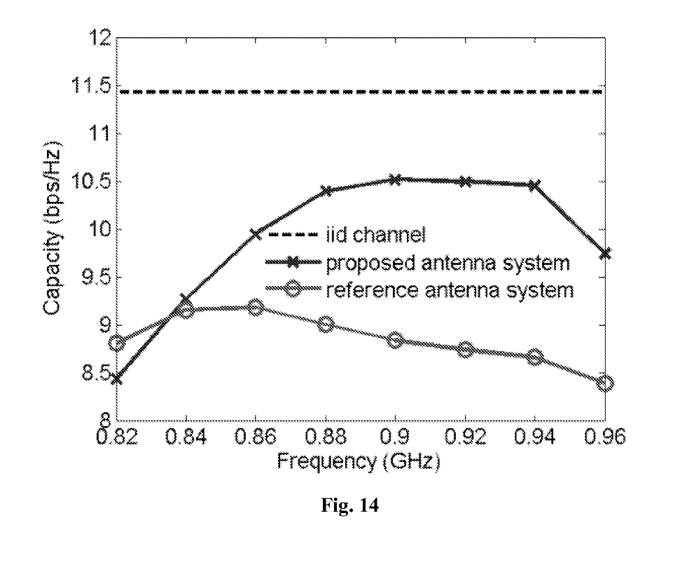

The channel capacities for three cases are presented in FIG. 14, i.e., the IID Rayleigh channel, the proposed dual-antenna terminal and the reference dual-antenna terminal. The IID case corresponds to the ideal situation of 100% total antenna efficiencies and zero correlation between the antennas. For LTE Band 8, for which the T-strip antenna is designed for, the average channel capacity is 1.7 bits/s/Hz higher than that of the reference antenna terminal. Even at LTE Band 5, the channel capacity of the proposed antenna is higher in general, even though the T-strip antenna is not well matched. The only exception is for frequencies below 840 MHz, since the reflection coefficient of the T-strip antenna is too high that it hardly radiates any power. Considering that the MIMO scheme in terminals is normally used for downlink, which corresponds to 869-894 MHz for LTE Band 5, the proposed antenna terminal significantly outperforms the reference antenna terminal. Compared with the IID channel, the drop of the channel capacity for the proposed antenna terminal is mainly due to its limited antenna efficiencies, since the correlation is quite low over the band of interest (below 0.07). It is worth noting that the substrate used for the T-strips is FR4 with relatively high loss tangent. If materials with lower loss tangents (e.g. 0.002) are used for the antenna casing, the total efficiency of the T-strip antenna can be increased by up to 10%, leading to higher channel capacity of the proposed antenna terminal.

### C. User Effects

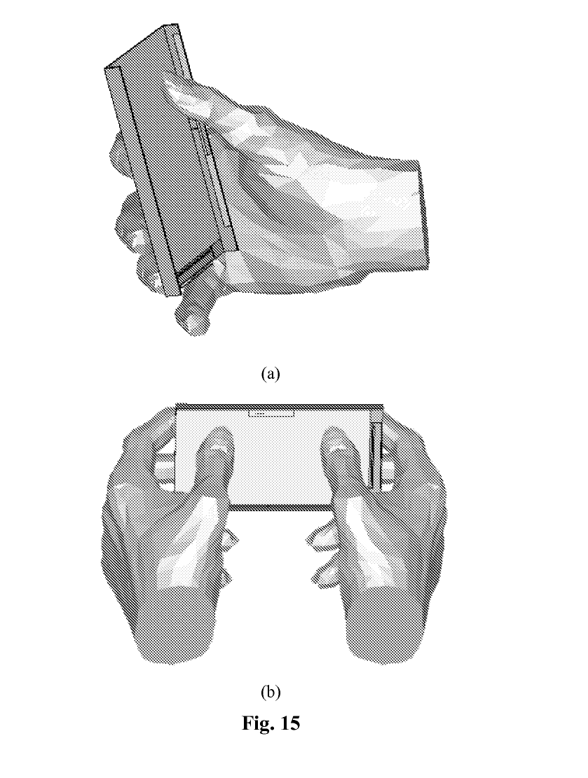

This subsection explores the effects of hand loading on the performance of the proposed dual-antenna terminal. Two scenarios, i.e. one-hand (OH) data mode and two-hand (TH) data mode, are investigated. FIG. 15 illustrates the position of the hands with respect to the terminal for the two scenarios. Those two specific scenarios are chosen because they are representatives of common user cases, where users either browse their devices or play games.

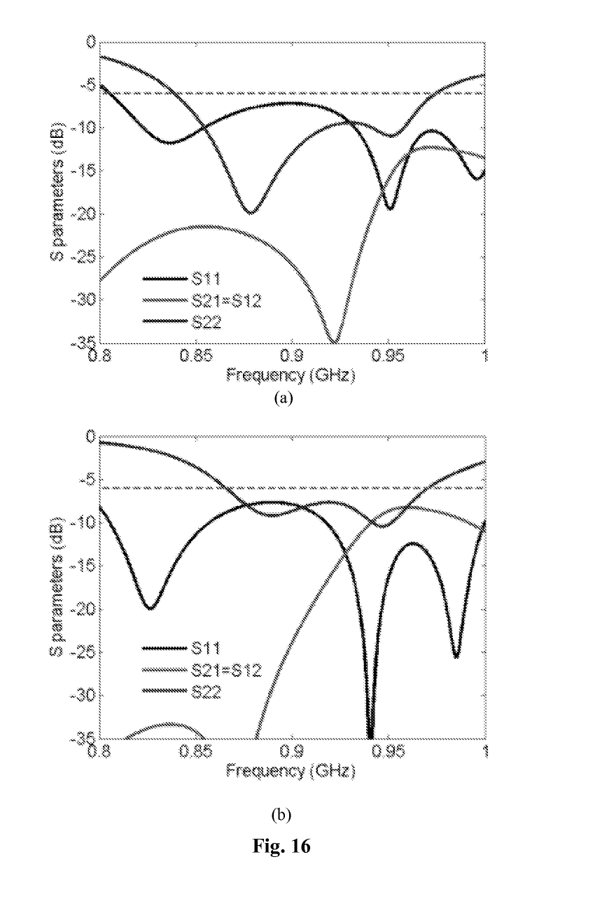

FIG. 16 presents the S parameters for the one-hand and two-hand cases. In general, the proposed antenna system fully covers the LTE Band 8 for all the scenarios, with the monopole also covers LTE Band 5 in each scenario. For the one-hand data mode, the impedance bandwidth becomes larger since the impedance matching of the T-mode is improved by the proximity of the hand to the T-strip. The D-mode almost remains the same as in free space (see FIG. 11). The port isolation between the antennas becomes higher compared with free space scenario, owing to the high absorption loss in the hand tissue. For the two-hand data mode, the impedance matching of the T-mode is almost unchanged, whereas the D-mode is better matched. The isolation at around 960 MHz is not improved in this scenario. This is because the two hands highly reflect the electromagnetic waves of both antennas, forcing the patterns to become more correlated and inducing higher mutual coupling. Nevertheless, the hand loss still reduces the mutual coupling to some extent. The more correlated patterns can be confirmed by the envelope correlation coefficients for the three different scenarios shown in FIG. 17(a). In general, the correlation coefficients in the proposed antenna terminal are very low for all the scenarios, with only one exception for the two-hand data mode at 960 MHz due to the aforementioned reasons. Nonetheless, the rule of thumb is that the envelope correlation should be no higher than 0.5 for good MIMO performance, which is satisfied even at 960 MHz.

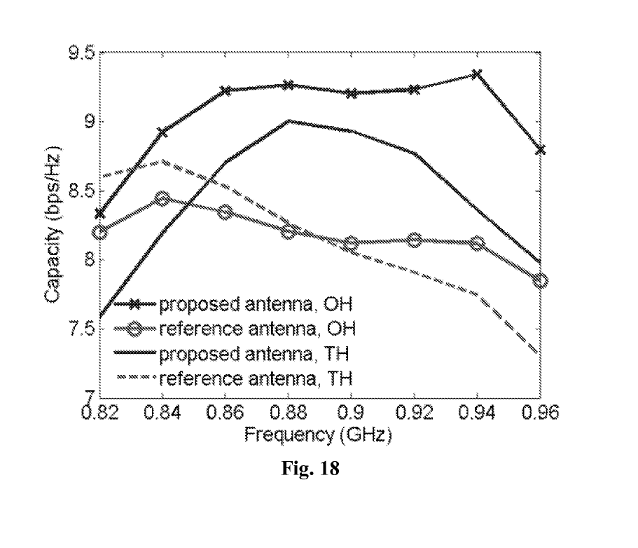

The total efficiencies of the dual-antennas in different scenarios are shown in FIG. 17 (b). Compared with the free space scenario, efficiencies of both the monopole and the T-strip antenna in one hand scenario drop by 2 dB at LTE Band 8. However, at 820 MHz-850 MHz, the efficiency of the T-strip antenna in one-hand senario even outperforms that in free space, due to its better impedance matching. In the two hand senario, the efficiency of the T-strip antenna is similar as that in one hand case, whereas the efficiency of the monopole is decreased by another 1 dB. Since the impedance matching is good for all the scenarios, the drop of efficiencies is mainly due to the loss in hand tissues. The channel capacities of the proposed dual-antenna system with user effects are shown in FIG. 18, together with those of the reference antenna system. It reveals that the proposed antenna still outperforms the reference antenna by 1-1.5 bits/s/Hz in different scenarios.

### V. EXPERIMENTS AND DISCUSSIONS

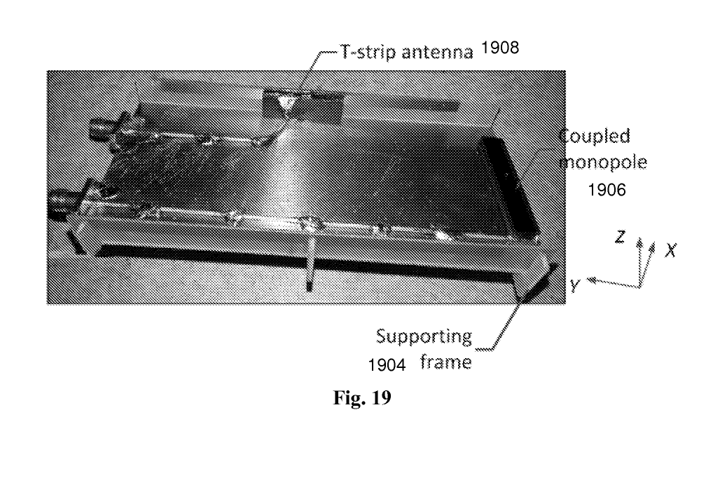

The proposed T-strip antenna system was fabricated and shown in FIG. 19. Six L-shaped supporting frames 1904 are used to connect the substrate of the T-strip antenna 1908 with the flat chassis. The influence of the supporting frames 1904 was studied in the simulation, which decrease the resonant frequency of the T-strip antenna 1908 by 2 MHz and deteriorate the matching by 0.5 dB. The SMA feeds of the two antennas 1908, 1906 are placed at the shorter edge of the chassis, since the longer edges of the chassis are occupied by the T-strip antenna 1908. The SMA connectors slightly affect both S parameters and radiation patterns of both antennas. On one hand, the SMA connectors are an extension of the chassis, which slightly decrease the resonant frequency of the coupled monopole 1906 and influence the matching. On the other hand, they act as scatterers around the chassis, distorting the antenna patterns and changing the capacitance between the two T-strips.

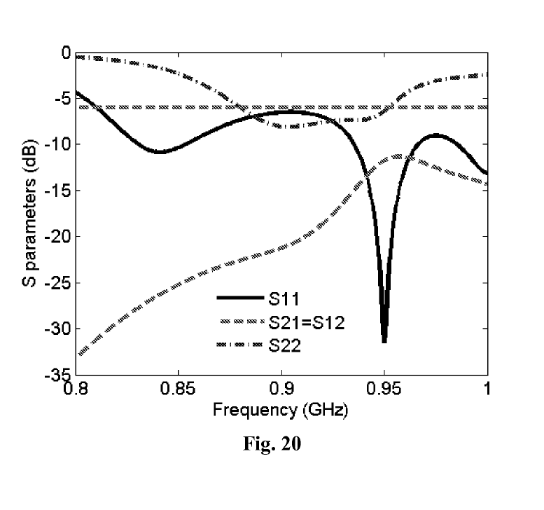

The S parameters were measured with a vector network analyzer and shown in FIG. 20. The measured results show that both antennas operate at GSM900 band, with isolation above 10 dB.

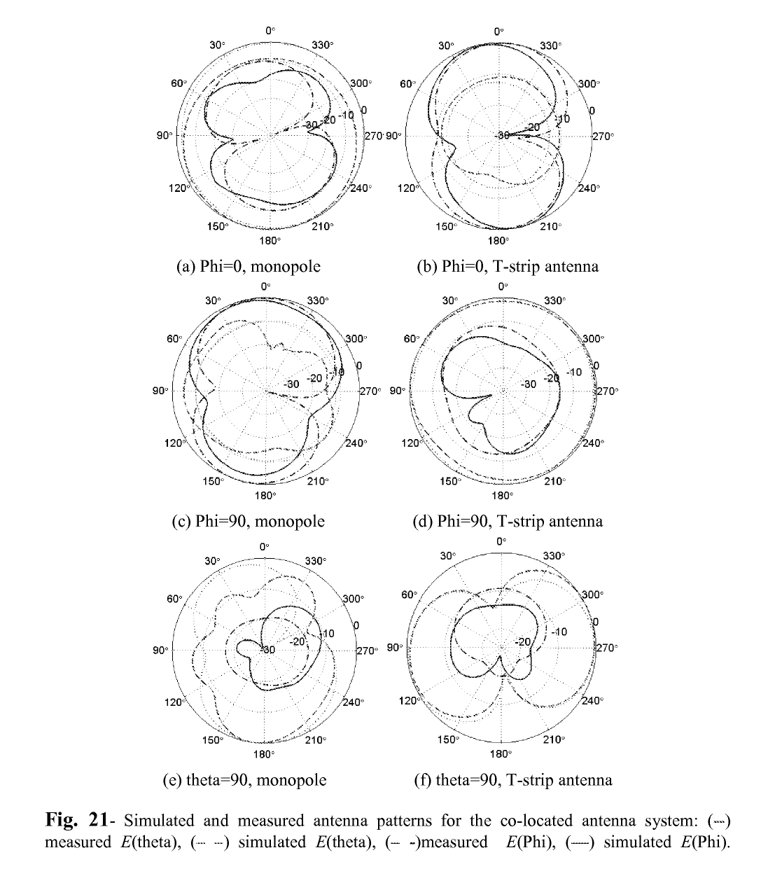

The far-field patterns and efficiencies of the antenna were measured in a Satimo Stargate-64 antenna measurement facility. Generally speaking, the measured patterns agree well with the simulated ones, as presented in FIG. 21. At phi=90 plane, i.e., yoz plane, slight difference occurs around theta=90, which corresponds to the location of the SMA connector and the feed cables. The difference in the plane of theta=90 is due to the same reason. From the measured radiation patterns, it is clear that both pattern and polarization diversities are achieved in the proposed antenna. The correlations calculated from the measured patterns are 0.1, 0.12 and 0.16, respectively, at 880 MHz, 920 MHz and 960 MHz, which are higher than those in the simulation. This is attributed to cable influence and practical difficulties in measuring antennas with very low correlation.

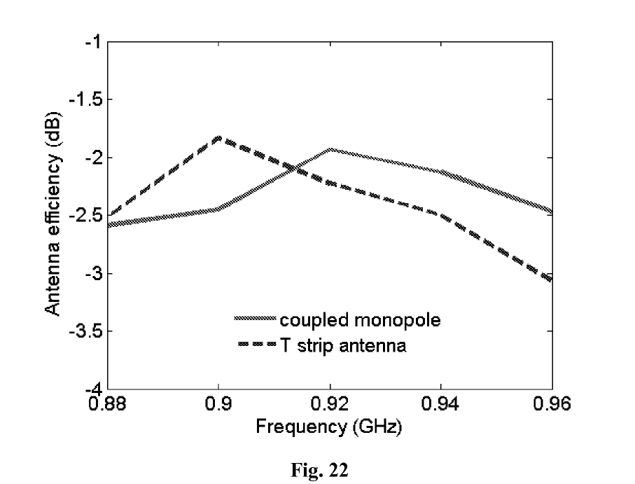

The measured efficiencies for the coupled monopole and the T-strip antenna at GSM900 band are presented in FIG. 22, which are around 0.5 dB lower than the simulated efficiencies. One reason for the efficiency drop is the additional resistive loss incurred in the non-ideal capacitors as well as the solder joints in the fabricated antenna (see FIG. 19), especially the joints connecting the feed cables and the antenna structures. Moreover, during the pattern measurement, the antenna was supported by bulk foams with a loss tangent of 0.002, which introduce some losses.

### VI. CONCLUSION

In this work, a novel and practical approach to design dual antennas with very low correlation on the mobile chassis was proposed at frequency below 1 GHz. By manipulating the chassis in a reasonable manner, two orthogonal modes were created. According to the concept, two modifications of the chassis were made, i.e., bezel loaded chassis and T-strip loaded chassis. For the reason of larger bandwidth, the T-strip loaded chassis was employed to build a second antenna apart from the coupled monopole, which takes advantage of the fundamental dipole mode. The coupled monopole operates at GSM850 and GSM900 bands, whereas the T-strip antenna covers GSM900 band. The correlation between the two antennas in free space is below 0.1 over the operating bands. The user effects, including both one-hand scenario and two-hand scenario, were studied. It reveals that the S parameters of both antennas were not severely influenced by the hands, but the efficiencies were decreased due to body loss. Comparisons between the proposed antenna and a reference dual-monopole design were carried out through channel capacity, where an improvement of 1.5 bits/s/Hz is obtained by the proposed design for a reference SNR of 20 dB. The prototype of the proposed dual-antenna system was fabricated and measured, and the results were found to be in reasonable agreement with those from simulations.

### APPENDIX A

Further information of the invention is provided in this section. Specifically, efforts had been directed towards establishing the practicality of the dual-mode, low-correlation antenna structure. The achievements include the following findings: (1) the T-strip structure (Section II-B) can be tuned to as low as 650 MHz, allowing it to cover the LTE700 band, (2) the bandwidth of the T-strip structure can be increased to beyond 70 MHz at 700 MHz, (3) multiband resonance is feasible for the T-strip structure, with minor modifications, and (4) the influence of battery and glass display on antenna performance was studied in simulation and results show only minor impact for the studied cases. Some key results are provided in the following sections.

### A-I. Multiband T-Strip Structure

Different structures that were attempted yielded performances that fall between the structures giving the bezel mode (Section II-A) and the T-strip mode (Section II-B). One particular structure resembling the T-strip structure has been found to be capable of creating multiple independent resonances that can be tuned to the bands shown in Table 1. The term “independent resonances” means that the resonances can be individually tuned, with no resonance being a higher-order resonance of another resonance.

TABLE 1
Excitable Independent Modes in Modified T-strip Structure

| | Min Freq | Max Freq | Average |
|---|---|---|---|
| | [MHz] | [MHz] | Bandwidth |
| Band 1 | 650 | 1100 | 8.50% |
| Band 2 | 1350 | 2100 | 8.10% |
| Band 3 | 2500 | 3000 | 6.20% |

The average percentage bandwidth in each band varies depending on how each band is match. In order to effectively feed this structure two lumped elements are needed. It is feasible to increase the percentage bandwidth through means of utilizing more lumped elements; however, in many cases this will significantly impact the antenna efficiency, since lumped elements introduce losses. In this appendix, only the structure covering the 824-894 and the 1850-1990 MHz bands will be described in detail.

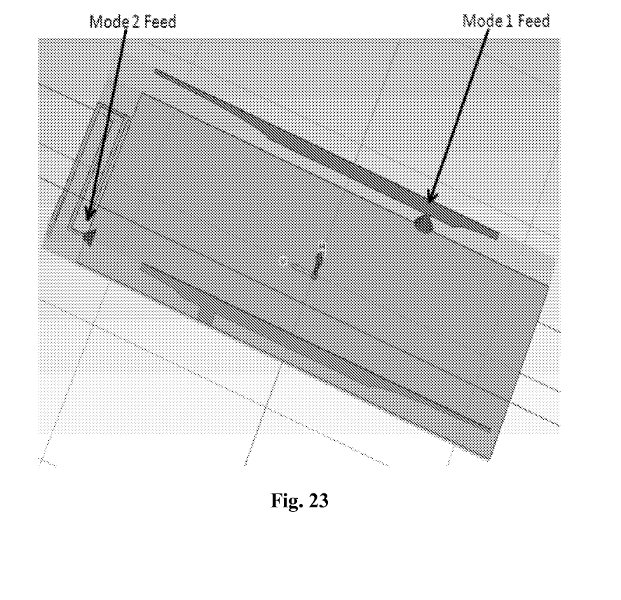

FIG. 23 shows the shape of the modified structure which largely resembles the T-strip structure. However, due to the structure shape, feed position, and feed type, different characteristic modes are formed in this structure.

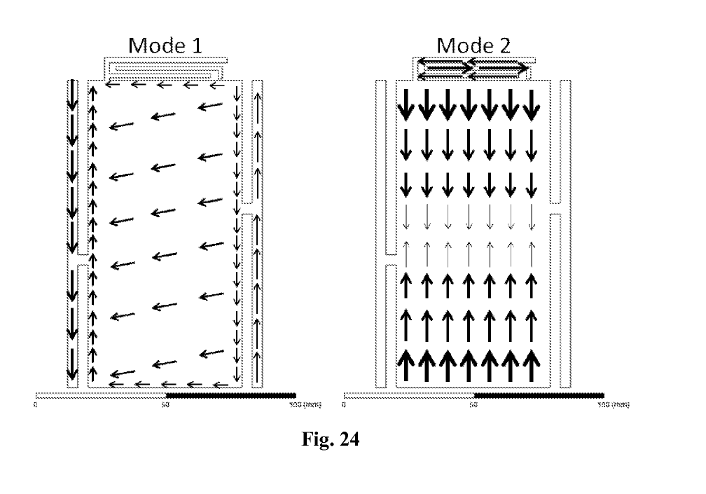

The currents that this structure produces in the low band of operation are outlined in FIG. 24. Mode 1 shows the currents that form when feeding the T-mode while the currents in mode 2 are formed when feeding the structure with a standard chassis mode excitation (i.e., fed with a coupled-monopole). These currents are highly orthogonal and therefore lead to low mutual coupling and orthogonal patterns, giving high total efficiencies and low correlation, which in turn lead to high capacity in MIMO operation.

However, these modes of operation are only usable if acceptable impedance matching can be obtained. In order to obtain a better match and a dual resonance in the low band of operation an offset feed was adapted to this structure. This offset feed allows the currents to travel in the direction shown in FIG. 24. The long sides of the T-wings increase capacitance in the low band to help better the match of the structure. In order to obtain an effective match in the low band a few actions can be taken: decreasing the length of the long side of the T will decrease the resonance, increasing the width of the T moves the match clockwise while maintaining a constant absolute resistance, and decreasing the distance of the T from the ground plane increases the parallel capacitance of the feed. The low band feeding can be effectively compared to a top-loaded dipole.

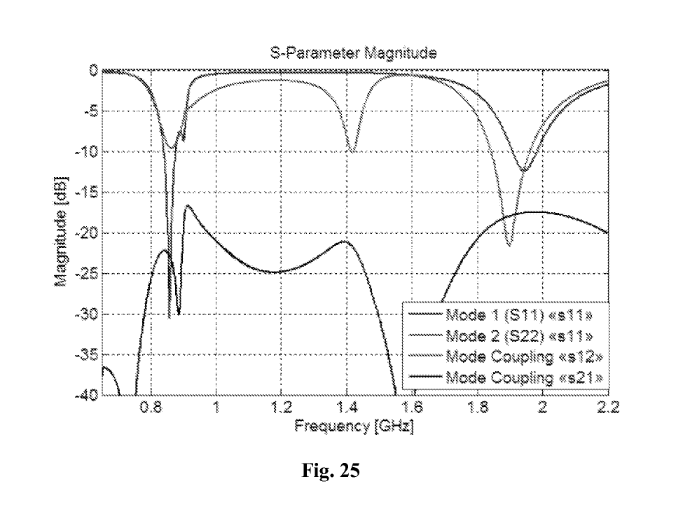

To match the high band the length of the entire wings sets the resonance frequency. The resonance frequency can be set higher or lower by increasing or decreasing the size of the smaller end of the T-strip structure without affecting the low band resonance. Utilizing a 5.1 nH inductor to ground and a series 4.7 pF capacitor on the feeding port a reasonable match was found to feed the first mode. The reflection and coupling coefficients for Modes 1 and 2 are shown in FIG. 25.

The two modes are highly isolated from one another. This is the expected result as two independent modes are being formed in both the low band as well as the high band. With further tuning efforts, even higher isolation can be obtained using this technique. However, isolation of greater than 15 dB (or even 10 dB) is already considered very good for practical purposes.

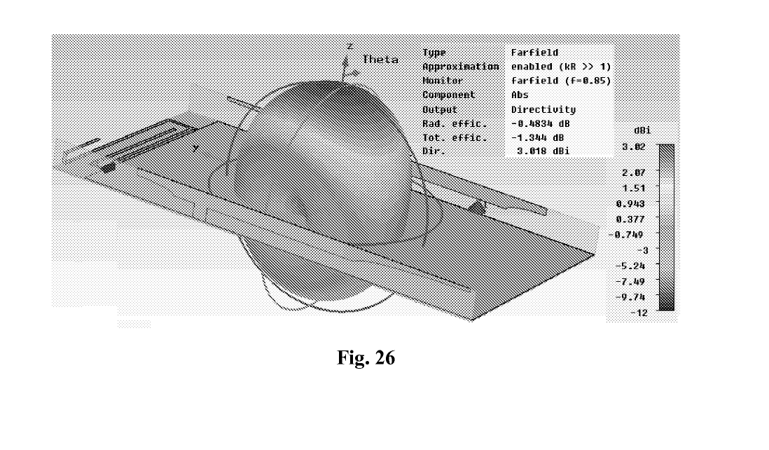

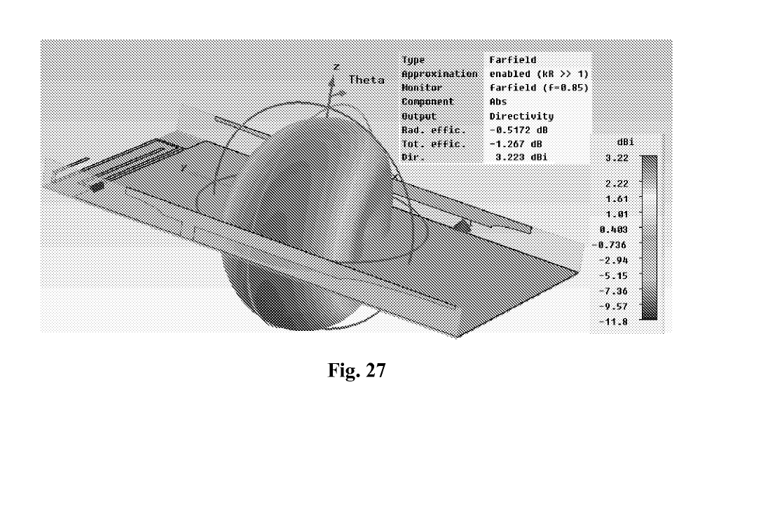

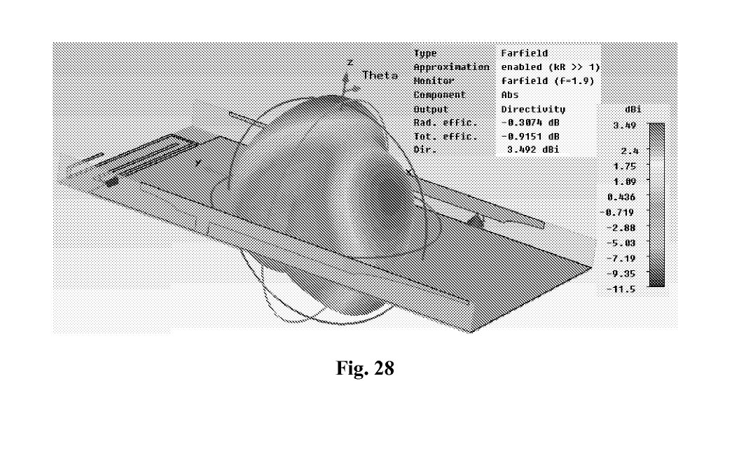

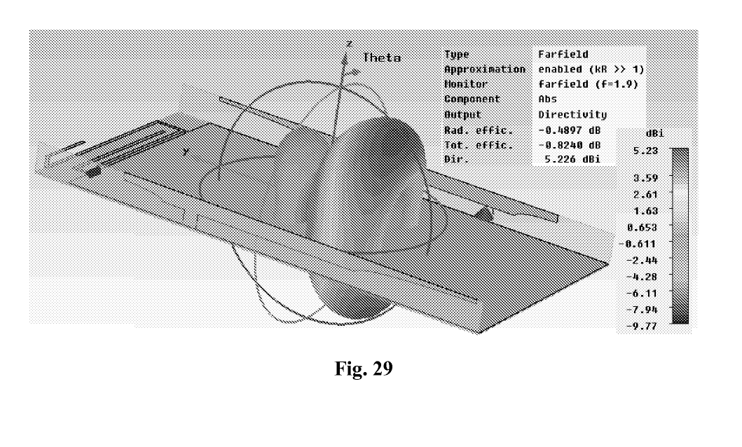

The far field patterns from the low band and the high band were analyzed to evaluate the correlation coefficient between the two modes of operation. The far field patterns for each mode of operation are shown in FIGS. 26-29.

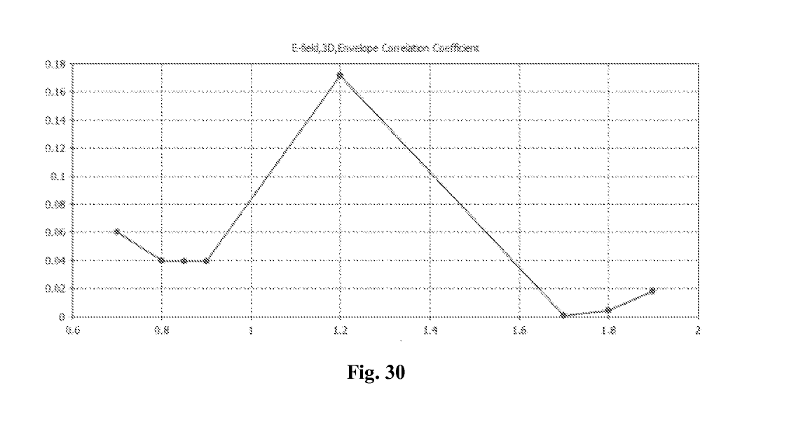

The envelope correlation of the far field patterns for the two modes were calculated and shown in FIG. 30. As can be seen, very low correlations of 0.06 or lower were obtained within the two bands of interest.

### A-II. Impact of Battery and Display on Antenna Performance

In this section, two T-strip structures (i.e., single-band version of Section II-B and multi-band version of Section A-I) were analyzed in simulation with respect to the influence of common components of mobile handsets: metallic battery and glass display. The purpose is to study the influence of these components on impedance matching and the characteristic modes. If the influence is significant, then effective countermeasures will be necessary to restore the antenna performance.

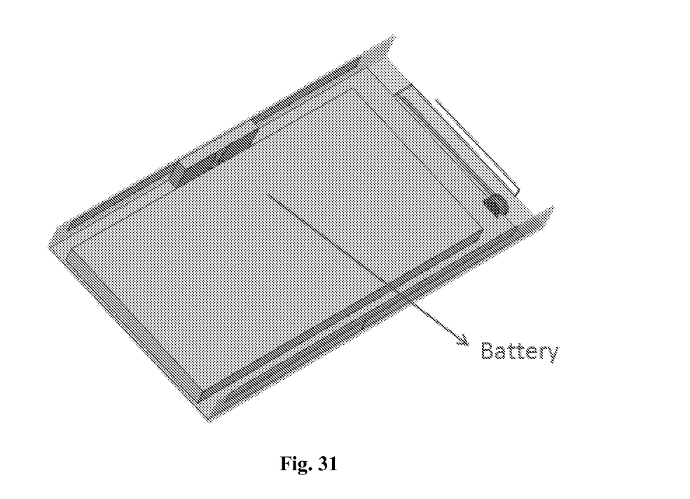

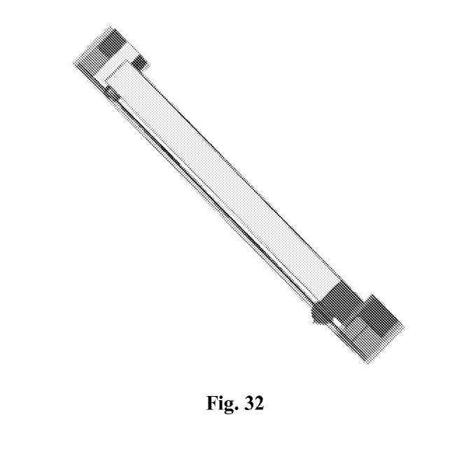

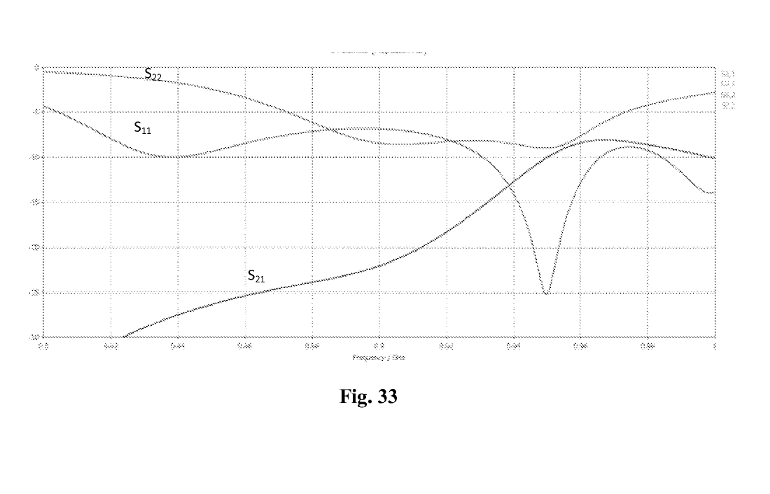

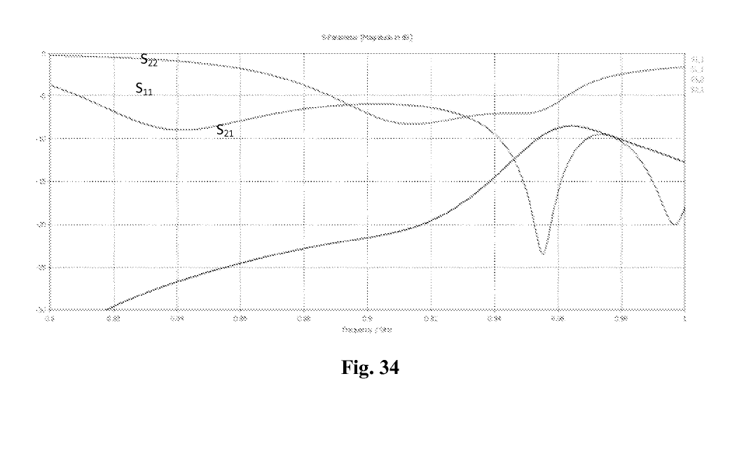

The simulation model of the single-band T-strip structure equipped with battery is shown in two viewing angles in FIGS. 31 and 32. The corresponding antenna performance in terms of scattering parameters without and with the battery is shown in FIGS. 33 and 34, respectively. As can be seen, the battery has only a small impact on the impedance matching, which can be retuned to restore the desired performance.

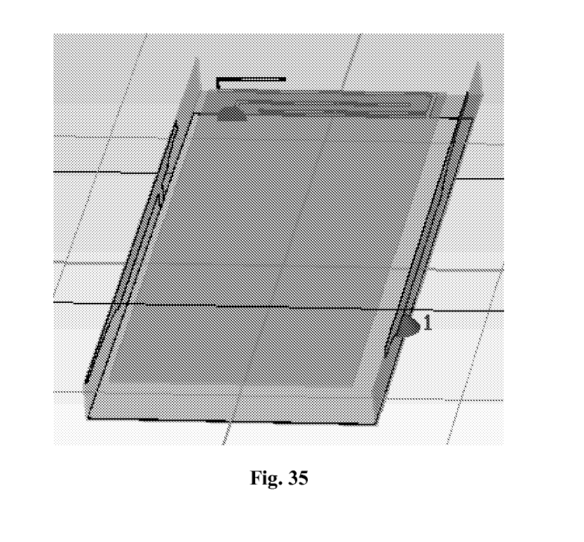

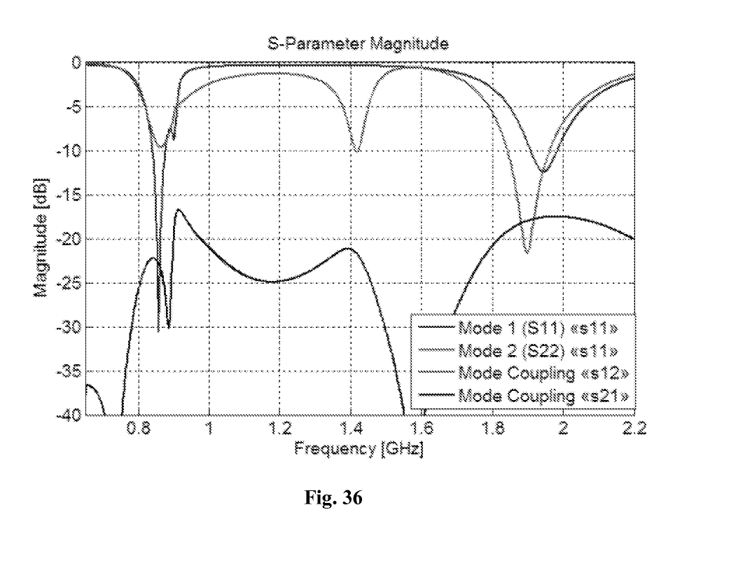

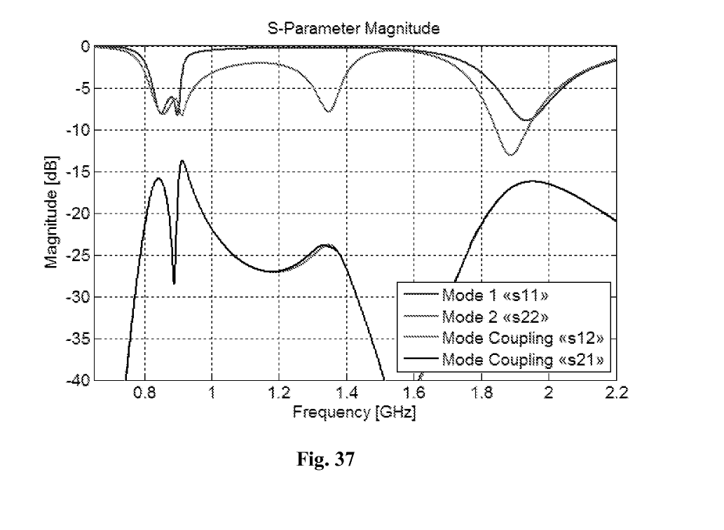

For the multiband T-strip structure, the impact of including a glass display was simulated (see FIG. 35). The S parameters of the structure without and with the glass display are shown in FIGS. 36 and 37, respectively. As in the case of battery inclusion, the glass display can be seen to have only a small impact on the antenna performance.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. As used herein, “at least one” shall mean “one or more” and these phrases are intended to be interchangeable. Accordingly, the terms “a” and/or “an” shall mean “at least one” or “one or more,” even though the phrase “one or more” or “at least one” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A mobile apparatus comprising:
a memory;
a processor; and
a chassis comprising at least one metallic part, the at least one metallic part enabling at least two antenna operational modes at frequency bands below 1 GHz.

2. A mobile apparatus comprising:
a memory;
a processor; and
a chassis defined by a first edge and a second edge, the first edge being shorter than the second edge, the chassis comprising a bezel, the bezel being connected to a point near the center of the first edge using a shorting pin.

3. The mobile apparatus of claim 2, wherein the mobile apparatus enables at least two operational modes, wherein the at least two modes comprise a fundamental dipole mode of the chassis and a bezel mode, and wherein the fundamental dipole mode and the bezel mode are substantially orthogonal to each other.

4. The mobile apparatus of claim 3, wherein the fundamental dipole mode has a larger bandwidth compared to the bezel mode.

5. The mobile apparatus of claim 3, wherein the fundamental dipole mode and the bezel mode are excitable substantially independently of each other.

6. A mobile apparatus that enables at least one characteristic mode to resonate at a frequency below 1 GHz, the apparatus comprising:
a memory;
a processor; and
a chassis defined by a first edge, a second edge, and a third edge, the first edge being shorter than the second edge and the third edge, the chassis comprising:
a first metal strip positioned along the second edge, the first metal strip being connected to a point near the center of the second edge using a first shorting pin; and
a second metal strip positioned along the third edge, the second metal strip being connected to a point near the center of the third edge using a second shorting pin.

7. The mobile apparatus of claim 6, wherein the mobile apparatus enables at least two operational modes at a frequency below 1 GHz, wherein the at least two modes comprise a fundamental dipole mode of the chassis and a T-mode.

8. The mobile apparatus of claim 7, wherein the T-mode is associated with at least one of the first metal strip or the second metal strip, and wherein the fundamental dipole mode and the T-mode are substantially orthogonal to each other.

9. The mobile apparatus of claim 7, wherein at least one of a resonant frequency or a bandwidth of the T-mode is based on a width of at least one of the first shorting pin or the second shorting pin.

10. The mobile apparatus of claim 7, wherein at least one of a resonant frequency or a bandwidth of the T-mode is based on a height of at least one of the first metal strip or a height of the second metal strip.

11. The mobile apparatus of claim 7, wherein the fundamental dipole mode and the T-mode are excitable substantially independently of each other.

12. The mobile apparatus of claim 7, further comprising a metal plate positioned substantially parallel to the chassis, the metal plate being configured to create capacitive coupling near the center of the second edge or the third edge, wherein the metal plate is connected to the first metal strip or the second metal strip, and wherein the metal plate is fed by a feeding strip.

13. The mobile apparatus of claim 7, wherein first quadrilateral shapes are etched into the first metal strip substantially symmetrically about the first shorting pin, and wherein second quadrilateral shapes are etched into the second metal strip substantially symmetrically about the second shorting pin.

14. A mobile apparatus that enables at least one characteristic mode to resonate at a frequency below 1 GHz, the apparatus comprising:
a memory;
a processor; and
a chassis defined by a first edge, a second edge, and a third edge, the first edge being shorter than the second edge and the third edge, the chassis comprising:
a T-strip antenna comprising:
a first metal strip positioned along the second edge, the first metal strip being connected to a first point along the second edge using a first shorting pin;
a second metal strip positioned along the third edge, the second metal strip being connected to a second point along the third edge using a second shorting pin; and
a metal plate positioned substantially parallel to the chassis, the metal plate being configured to create capacitive coupling along the second edge or the third edge, wherein the metal plate is connected to the first metal strip or the second metal strip; and
a second antenna.

15. The mobile apparatus of claim 14, wherein operating the mobile apparatus enables at least two operational modes at a frequency below 1 GHz, wherein the at least two modes comprise a fundamental dipole mode and a T-mode, wherein the T-mode is associated with the T-strip antenna, wherein the fundamental dipole mode is associated with the second antenna, and wherein the T-mode and the fundamental dipole mode are substantially orthogonal to each other.

16. The mobile apparatus of claim 15, wherein the second antenna comprises at least one of a coupled fed monopole antenna, a planar inverted-F antenna, or a slot antenna.

17. The mobile apparatus of claim 15, wherein the second antenna covers a larger bandwidth than the T-strip antenna.

18. The mobile apparatus of claim 15, wherein the T-strip antenna covers the LTE Band 8 (880-960 MHz) and the fundamental dipole mode covers both LTE Band 5 (824-894 MHz) and LTE Band 8.

19. The mobile apparatus of claim 15, wherein the T-mode and the fundamental dipole mode remain substantially orthogonal to each other when a user is operating the mobile apparatus using either one hand or two hands.

20. The mobile apparatus of claim 15, wherein the first point is near or away from the center of the second edge, and wherein the second point is near or away from the center of the third edge.

21. The mobile apparatus of claim 20, wherein at least one of the second edge or the third edge is tapered along at least one end of the second edge or the third edge.

22. The mobile apparatus of claim 20, wherein the fundamental dipole mode and the T-mode cover one or more of the following low frequency LTE bands 5, 6, 8, 12, 13, 14, 17, 18, 19, and 20 in combination with one or more of high frequency LTE bands 1, 2, 3, 4, 9, 10, 11, 15, 16, 21, 23, 24, and 25.
